(19) United States
(12) Patent Application Publication
(10) Pub. No.: US 2024/0408535 A1
(43) Pub. Date: Dec. 12, 2024

(54) FULL TEMPERATURE RANGE SIMULATED ROTATED MOVING BED PSA PROCESS FOR EXTRACTING H2 AND NH3 FROM GAN-MOCVD PROCESS EXHAUST GAS

(71) Applicant: ZHEJIANG TECHAIRS CLOUD TECHNOLOGIES INC, JIAXING (CN)

(72) Inventors: YALING ZHONG, JIAXING (CN); LANHAI WANG, JIAXING (CN); YUN CHEN, JIAXING (CN); JINCAI TANG, JIAXING (CN); YUMING ZHONG, JIAXING (CN); YUEMING CAI, JIAXING (CN)

(21) Appl. No.: 18/812,078

(22) Filed: Aug. 22, 2024

Related U.S. Application Data
(63) Continuation of application No. PCT/CN2022/130758, filed on Nov. 9, 2022.

(30) Foreign Application Priority Data
Mar. 16, 2022 (CN) 202210259581.5

(51) Int. Cl. B01D 53/047; B01D 53/06

(52) U.S. Cl. CPC B01D 53/047; B01D 53/06; B01D 2257/108; B01D 2257/406; B01D 2258/0216; B01D 2259/40028; B01D 2259/40052

(57) ABSTRACT

A full temperature range simulated rotated moving bed PSA process for extracting H₂ and NH₃ from GaN-MOCVD exhaust gas, includes a medium and high temperature PSA ammonia concentration system and an intermediate gas PSA hydrogen purification system, which include multiple axial flow fixed bed adsorption towers arranged in the center of upper and lower two multichannel rotary valves, mounted on the periphery of an annular rotary tray, and connected through pipelines. For the gas flowing through rotary valve channels, pipelines between inlet and outlet ends of the channels and inlet and outlet ends of the adsorption towers, and adsorption bed layers, mass transfer in respective adsorption and desorption steps is completed while the gas entering and exiting the inlets and outlets of the adsorption towers and adsorption bed layers while rotating. Thus, the simulated rotated moving bed PSA process is formed.

### TECHNICAL FIELD

The disclosure relates to the field of pressure swing adsorption (PSA) separation and purification of hydrogen (H₂) and ammonia (NH₃) in the semiconductor industry, and more specifically relates to a full temperature range simulated rotated moving bed PSA process for extracting H₂/NH₃ from gallium nitride metal oxide chemical vapor deposition (GaN-MOCVD) process exhaust gas.

### BACKGROUND

A metal oxide chemical vapor deposition (MOCVD) process (equipment), as a modern method and means in researching and producing compound semiconductor materials, is an indispensable method (equipment) in the optoelectronics and semiconductor industry for manufacturing light-emitting diodes, lasers, detectors, high-efficiency solar cells, photocathodes, and other products based on gallium nitride (GaN) compound semiconductor materials. For example, blue and purple LEDs widely used in the market are produced using GaN based materials. An MOCVD epitaxial process uses a high-purity metal oxide (MO), such as trimethylgallium (TMGa), as an MO source, which is carried by an electron level carrier gas hydrogen (H₂) and/or nitrogen (N₂), and enters an MOCVD reactor with electron level ammonia (NH₃). On a sapphire (Al₂O₃) substrate heated to an appropriate temperature, the gaseous metal oxide TMGa is controlled to be transported to the surface of the sapphire substrate to grow a semiconductor thin film epitaxial material GaN having specific components, specific thickness, and specific electrical and optical parameters. To ensure complete reaction in an MOCVD reaction chamber, excessive H₂/N₂ and NH₃ are provided, resulting in production of MOCVD process exhaust gas containing plenty of H₂/N₂ and NH₃. The typical composition of MOCVD epitaxial exhaust gas of LED GaN includes: H₂: 55% (v/v, similar below), N₂: 25%, and NH₃: 14%, and the balance of small or trace amounts of metal ions, particulate matters, methane (CH₄), oxygen (O₂), and oxides such as carbon monoxide (CO), carbon dioxide (CO₂), and water (H₂O).

Due to the presence of the highly corrosive NH₃, the flammable and explosive H₂, the metal ions, and the oxides in the GaN-MOCVD process exhaust gas produced by LED preparation, it is quite difficult to purify and recover NH₃ and return it to an LED process. At present, most LED chip manufacturers recover NH₃ by first removing or converting the corrosive NH₃ into ammonia water, ammonium fertilizer, and the like by various means such as water washing, catalytic conversion, adsorption, and distillation. The NH₃ provided in the LED-MOCVD process still needs to be supplied by a specialized gas company. Due to low concentration of H₂ and a large amount of N₂, the exhaust gas after deamination is generally further processed such as removal of harmful and toxic impurities by catalytic combustion or acid-alkali washing and then enters a hydrogen emission system or is directly vented, or H₂ is recovered by traditional axial flow fixed bed PSA.

Several traditional methods mainly recovering NH₃ from ammonia containing waste gas, such as a freezing method, a water washing (water rising) method, a sulfuric acid absorption method, a phosphate (ammonium) absorption and distillation coupling method, an organic solvent absorption method, an adsorption method (mainly TSA), an adsorption and distillation coupling method, a catalytic combustion method, and a catalytic ammonia decomposition method, have a long process, can only produce intermediate products such as industrial ammonia water or amine fertilizer for utilization, but cannot directly recover and return ammonia to a GaN-MOCVD process for recycling. The temperature swing adsorption (TSA) method is only suitable for deamination purification of exhaust gas with a low ammonia concentration, and the purified gas which meets an emission requirement is emitted. However, the desorbed gas after adsorption is rich in ammonia, which is produced into ammonia water, ammonia fertilizer, and the like through water absorption, etc. Or through catalytic combustion, combustible components such as ammonia, hydrogen, and methane in the exhaust gas are subjected to high-temperature catalytic oxidation, and then the exhaust gas is subjected to subsequent treatment and emitted when meeting the emission standard, but ammonia cannot be directly recovered and reused. The catalytic ammonia decomposition method is to perform catalytic decomposition of ammonia in exhaust gas with a high ammonia concentration at high temperature into H₂ and N₂, which are then recovered after treatment, but ammonia cannot be recovered and reused either.

The existing new technologies for recovering H₂ and NH₃ from GaN-MOCVD process exhaust gas typically include Chinese patent “Full Temperature range PSA Full Component Recovery and Recycling Method from LED-MOCVD Process Exhaust Gas (CA 201810532108.0)”, US patents “Methods of Extracting and Recycling Hydrogen from MOCVD Process Exhaust Gas by FTrPSA (U.S. Ser. No. 16/423,167)”, and “Methods of Extracting and Recycling Ammonia from MOCVD Process Exhaust Gas by FTrPSA (U.S. Ser. No. 16/423,181)”, etc. The above processes involve an ammonia concentration PSA process including 5-6 adsorption towers in a first stage, with the maximum condensation rate of about 90%. However, non-adsorbed phase gas generated in the ammonia concentration process, which remains in an H₂ purification process including 5-6 adsorption towers in a second stage, has a relatively high residual concentration of ammonia, as PSA hydrogen purification feed gas entering the second stage. Therefore, the PSA hydrogen purification efficiency in the second stage greatly decreases, residual ammonia needs to be absorbed by additional water washing, and trace amounts of ammonia needs to be purified and removed by TSA, resulting in a longer process flow, higher investment, and larger occupation of area. In particular, an axial flow fixed bed PSA process in the second stage uses a large number of matched program control valves and regulating valve groups, which greatly affects stable device operation and cost. Also, when the ammonia yield reaches 98%, the H₂ yield is only 75-85%, and thus high purity and high yield of simultaneous recovery of H₂/NH₃ cannot be achieved.

### SUMMARY

The disclosure provides a new process called Full Temperature range Simulated Rotated moving PSA (FTrSRMPSA) for separating and extracting H₂ and NH₃ from GaN-MOCVD process exhaust gas. The process is a pressure swing adsorption (PSA) based method that makes the most of the temperature and pressure of GaN-MOCVD process exhaust gas, as well as the differences in adsorption separation coefficients and physicochemical properties between H₂—N₂ and the main adsorbate NH₃ component in the feed gas in a temperature range of 60-130° C. and a pressure range of 0.2-4.0 MPa. The process includes a medium and high temperature PSA ammonia concentration system and an intermediate gas PSA hydrogen purification system, which form a system with compressors, condensing freezers, heat exchangers, buffer tanks and process pipelines, and include multiple axial flow fixed bed adsorption towers arranged in the center of upper and lower two multichannel rotary valves, mounted on the periphery of an annular rotary tray, and connected through pipelines, and mechanisms for regulating the rotation direction and speed as well as the rotation direction and speed of the annular rotary tray. For the gas flowing through rotary valve channels, pipelines connected between the inlet and outlet ends of the channels and the inlet and outlet ends of the adsorption towers, and adsorption bed layers rotated and moved in the adsorption towers, mass transfer in respective adsorption and desorption steps is completed while the gas entering and exiting the inlet and outlet of each adsorption tower and each adsorption bed layer while rotating. Thus, the simulated rotated moving bed PSA process is formed, a simulated rotated moving bed PSA process based on axial flow fixed bed PSA is achieved, and H₂ and NH₃ products with high purity and high yield are obtained by adsorption and desorption multistep cycle operation and returned to a GaN-MOCVD process for recycling. The specific solution is as follows:

A full temperature range simulated rotated moving bed PSA process for extracting H₂ and NH₃ from GaN-MOCVD exhaust gas is provided, where the full temperature range simulated rotated moving bed PSA system includes a multi-tower medium temperature PSA concentration system (including a driving mechanism) with n (4≤n≤40, a natural integer) adsorption towers, a multi-tower medium and low temperature intermediate gas PSA system (including a driving mechanism) with n′ (4≤n′≤40, a natural integer) adsorption towers, an H₂ product gas (H₂PG)/feed gas (F)/intermediate gas (IG)/nitrogen-rich desorbed gas (N₂D) buffer tank, a liquid ammonia product storage tank, a feed gas compressor 1/intermediate gas compressor 2, a feed gas heat exchanger 1 (heater)/ammonia concentrated gas heat exchanger 2 (cooler)/condenser freezer, and corresponding material and process pipelines. The medium and high temperature PSA ammonia concentration system including the n axial flow fixed composite bed adsorption towers (“n adsorption towers” for short) loaded with various adsorbents and having a certain height to diameter ratio, and the intermediate gas PSA hydrogen purification system including the n′ axial flow fixed composite bed adsorption towers (“n′ adsorption towers” for short) loaded with various adsorbents and having a certain height to diameter ratio, are formed by the n adsorption towers and the n′ adsorption towers (i.e., n+n′ adsorption towers) arranged uniformly at intervals respectively on the annular rotary tray with a rotation speed of ω2 (second/revolution), the corresponding driving mechanisms, m (5≤m≤36, a natural integer) channels and m′ (5≤m′≤36, a natural integer) channels arranged in the center of the annular tray, and the upper and lower two independently rotating multichannel rotary valves with the rotation speeds of ω₁ (second/revolution) and ω₁′ (second/revolution) respectively. The upper rotary valve is called an m-channel rotary valve for short, and the lower rotary valve is called an m′-channel rotary valve for short. Inlet and outlet ends of the m- and m′-channels are respectively connected to inlets and outlets of the m-/m′-channel rotary valves, inlets and outlets of the internal pipelines of the rotary tray, and inlet and outlet ends of the n/n′ adsorption towers through material and process pipelines that are respectively connected to the internal pipelines of the annular rotary tray and the inlet and outlet ends of corresponding n adsorption towers/n′ adsorption towers and connected to the H₂ product gas/feed gas/intermediate gas/nitrogen-rich desorbed gas buffer tanks and the feed gas compressor 1/heat exchanger 1/intermediate gas compressor 2/ammonia concentrated gas heat exchanger 2/ammonia condenser freezer. The process flow is as follows: the exhaust gas generated in a GaN-MOCVD epitaxial process is used as the feed gas (F), which typically includes the following main components: 55% (v/v, similar below) of hydrogen (H₂), 25% of nitrogen (N₂), 20% of ammonia (NH₃), and the balance of small or trace amounts of metal ions, particulate matter, methane (CH₄), oxygen (O₂), and oxides including carbon monoxide (CO), carbon dioxide (CO₂) and water (H₂O) at a temperature of 25-40° C. and a normal or slightly positive pressure. The feed gas (F) flowing out of the feed gas buffer tank, which is heated by the heat exchanger 1 to 80-120° C. and pressurized by the compressor 1 to 0.6-0.8 MPa, enters the channels of the m-channel rotary valve in the medium and high temperature PSA ammonia concentration system, and enters a certain adsorption tower of the n adsorption towers through the internal pipelines of the annular rotary tray, for medium and high temperature PSA ammonia concentration. Ammonia concentrated gas (NH₃CG) consisting of ammonia-rich depressurization gas (NH₃D) and ammonia-rich purge waste gas (NH₃PW) continuously produced from the system has an ammonia concentration of greater than or equal to 90-95%, and is cooled to 25-40° C. by the heat exchanger 2 before entering an ammonia condensation and refrigeration unit. A resulting condensate is a liquid ammonia product (NH₃PL), which has a concentration of 99.99-99.999% and a yield of 98-99%, and is fed into a liquid ammonia product tank. Resulting non-condensable gas enters the intermediate gas (IG) buffer tank as low pressure intermediate gas (LPIG), and the non-adsorbed phase gas flowing out of the medium and high temperature PSA ammonia concentration system enters the intermediate gas (IG) buffer tank as low pressure intermediate gas (LPIG), flows out of the buffer tank together with the non-condensable gas as the low pressure intermediate gas (LPIG), and is pressurized by the intermediate gas (IG) compressor 2 to 2.0-3.0 MPa to form high pressure intermediate gas (HPIG). The high pressure intermediate gas (HPIG) enters the channel of the m′-channel rotary valve of the intermediate gas PSA hydrogen purification system, and enters a certain adsorption tower of the n′ adsorption towers through an internal pipeline of the annular rotary tray, for intermediate gas PSA hydrogen purification. A non-adsorbed phase hydrogen gas product (H₂PG) is continuously produced from the system, and has a purity of 99.99-99.999% and a yield of 92-95%. The nitrogen-rich desorbed gas (N₂D) of the absorbed phase continuously flowing out of the system enters the nitrogen-rich desorbed gas (N₂D) buffer tank and flows out, or is directly discharged, or is subjected to cryogenic nitrogen production and H₂ recovery, or undergoes membrane separation for H₂ recovery. Thus, a complete full temperature range simulated rotated moving bed PSA (FTrSRMPSA) separation and purification process for producing high-purity and high-yield H₂ and NH₃ from GaN-MOCVD process exhaust gas as the feed gas is formed. A high-purity H₂ product gas (H₂PG) with a purity greater than or equal to 99.99% and a yield greater than or equal to 92%, and a liquid ammonia product (NH₃PL) with a purity greater than or equal to 99.99% and a yield greater than or equal to 98% are obtained from the GaN-MOCVD process exhaust gas, and returned to the GaN-MOCVD process for recycling.

Further, in the full temperature range simulated rotated moving bed PSA process for extracting H₂ and NH₃ from GaN-MOCVD exhaust gas, the regulation and matching of rotation directions of the m- and m′-channel rotary valves and the annular rotary tray in the medium and high temperature PSA ammonia concentration system and the intermediate gas PSA hydrogen purification system and rotation speeds (ω₁, ω₁′ and ω₂) thereof, include: 1) synchronization in the same direction, i.e., rotating clockwise or counterclockwise in the same direction, with ω₁=ω₁′=ω₂/≠0, and 2) asynchronization in the same direction, i.e., rotating clockwise or counterclockwise in the same direction, with either ω₁≠0≥ω₁′≠0/ω₂=0, or ω₁≠0≤ω₁′≠0/ω₂=0, or ω₁=ω₁′=0/ω₂≠0, preferably, asynchronization in the same direction, i.e., clockwise or counterclockwise rotation in the same direction with ω₁≠0≤ω₁′≠0/ω₂=0.

Further, in the full temperature range simulated rotated moving bed PSA process for extracting H₂ and NH₃ from GaN-MOCVD exhaust gas, the n adsorption towers in the medium and high temperature PSA ammonia concentration system sequentially and alternately go through adsorption and desorption cycle operation steps of adsorption (A), equalization drop (ED)/purge pressurization (PP), depressurization (D)/purge (P), equalization rise (ER)/waiting area (-), and final repressurization (FR), where the maximum number of times of equalization is 2, including first equalization drop (E1D)/first equalization rise (E1R) and second equalization drop (E2D)/second equalization rise (E2R); the steps of purge pressurization (PP) and waiting (-) need to be flexibly arranged according to the alternating timing of each adsorption tower during the PSA cycle operations; the n adsorption towers sequentially and alternately going through the PSA cycle operation steps is achieved by regulation and matching of rotation directions of the m-channel rotary valve and the annular rotary tray in the medium and high temperature PSA ammonia concentration system and rotation speeds (ω₁ and ω₂) thereof, and each channel in the m-channel rotary valve alternately switching materials and process gas flowing in the PSA cycle operation process at regular intervals to enter the n adsorption towers to perform the PSA cycle operations.

Further, in the full temperature range simulated rotated moving bed PSA process for extracting H₂ and NH₃ from GaN-MOCVD exhaust gas, the n′ adsorption towers in the intermediate gas PSA hydrogen purification system sequentially and alternately go through adsorption and desorption cycle operation steps of adsorption (A), equalization drop (ED)/purge pressurization (PP), depressurization (D)/purge (P), equalization rise (ER)/waiting area (-), and final repressurization (FR), where the maximum number of times of equalization is 3, including first equalization drop (E1D)/first equalization rise (ER), second equalization drop (E2D)/second equalization rise (E2R), and third equalization drop (E3D)/third equalization rise (E3R); the steps of purge pressurization (PP) and waiting (-) need to be flexibly arranged according to the alternating timing of each adsorption tower during the PSA cycle operations; the n′ adsorption towers sequentially and alternately going through the PSA cycle operation steps is achieved by regulation and matching of rotation directions of the m′-channel rotary valve and the annular rotary tray in the intermediate gas PSA hydrogen purification system and rotation speeds (ω₁′ and ω₂) thereof, and each channel in the m′-channel rotary valve alternately switching materials and process gas flowing in the PSA cycle operation process at regular intervals to enter the n′ adsorption towers to perform the PSA cycle operations.

Further, in the full temperature range simulated rotated moving bed PSA process for extracting H₂ and NH₃ from GaN-MOCVD exhaust gas, purge gas (P) in the medium and high temperature PSA ammonia concentration system and the intermediate gas PSA hydrogen purification system which is either purge pressurization gas (PP)/intermediate gas (IG) from inside the system or H₂ product gas (H₂PG)/ammonia concentrated gas (NH₃CG) from outside the system is used to perform purge in batches through one or more openings in the rotary valve channels (conduits), with a maximum of 4 openings, preferably, the purge pressurization gas (PP) from inside the system is used as the purge gas (P).

Further, in the full temperature range simulated rotated moving bed PSA process for extracting H₂ and NH₃ from GaN-MOCVD exhaust gas, the depressurization (D) step in the medium and high temperature PSA ammonia concentration system and the intermediate gas PSA hydrogen purification system is performed by vacuumizing for desorption; an added vacuum pump is either connected to a stream pipeline of a desorbed gas (D) outlet rotary valve, or directly connected to an external pipeline connected to an outlet end of the adsorption tower on the annular rotary tray, with a control valve installed on the external pipeline, preferably, the added vacuum pump is directly connected to an external pipeline connected to the outlet end of the adsorption tower on the annular rotary tray, with a control valve installed on the external pipeline.

Further, in the full temperature range simulated rotated moving bed PSA process for extracting H₂ and NH₃ from GaN-MOCVD exhaust gas, final repressurization gas (FR) in the PSA cycle operation of the medium and high temperature PSA ammonia concentration system and the intermediate gas PSA hydrogen purification system is either the feed gas (F) from outside the system, or the intermediate gas (IG), or the ammonia concentrated gas (NH₃CG), or the H₂ product gas (H₂PG), and when the purity of the H₂ product gas (H₂PG) is greater than 99.99%, preferably, the H₂ product gas (H₂PG) is used as the final repressurization gas (FR).

Further, in the full temperature range simulated rotated moving bed PSA process for extracting H₂ and NH₃ from GaN-MOCVD exhaust gas, the n adsorption towers and the n′ adsorption towers of the medium and high temperature PSA ammonia concentration system and the intermediate gas PSA hydrogen purification system are respectively loaded with one or more combined adsorbents of active calcium chloride, activated carbon, and molecular sieves, and one or more combined adsorbents of aluminum oxide, silica gel, activated carbon, molecular sieve, and carbon molecular sieves, preferably, the adsorption towers in the two systems are loaded with two or more combined adsorbents to form composite adsorbent bed layers.

### Beneficial Effects of the Disclosure

(1) The disclosure simulates an adsorption and desorption cycle operation mode of a traditional full temperature range fixed composite bed layer PSA into a full temperature range rotary wheel moving bed PSA process, obtains, with higher efficiency, products H₂ and NH₃ with higher purity and yield than fixed bed layer or typical fan-shaped adsorption chamber rotary wheel PSA, breaks through the technical limitation of “inverse proportion between purity and yield” in conventional full temperature range fixed adsorption bed layers, significantly reduces the manufacturing complexity and cost of other moving bed PSA processes and equipment including rotary wheels, simultaneously obtains high-purity H₂ product gas and a liquid ammonia product with high yield from an adsorbed phase and a non-adsorbed phase in a PSA separation process of GaN-MOCVD process exhaust gas, and returns them to a GaN-MOCVD epitaxial process for recycling, where the H₂ product gas has a purity greater than or equal to 99.99-99.999%, and a yield greater than or equal to 92-95%, and the liquid ammonia product has a purity greater than or equal to 99.9-99.99%, and a yield greater than or equal to 98-99%.

(2) By regulating and matching the rotation directions and rotation speeds (ω)/ω₁′ and ω₂) of the m- and m′-channel rotary valves and the annular rotary tray of the medium and high temperature PSA ammonia concentration system and the intermediate gas PSA hydrogen purification system, the disclosure can achieve PSA cycle operations for adsorption and desorption with multiple combinations and multiple steps on a traditional fixed bed PSA process, can flexibly adjust according to the technical indicator requirements of the products H₂/NH₃, and includes a combination process of multi-channel rotary valves and traditional fixed bed PSA, a typical fan-shaped adsorption chamber rotary wheel PSA or fast wheel PSA moving bed process, and other existing moving bed PSA processes, such that H₂/NH₃ with high purity and yield can be extracted and recovered smoothly and continuously by the FTrSRMPSA process using the GaN-MOCVD process exhaust gas as the feed gas and returned to the GaN-MOCVD process for recycling, thereby reducing exhaust emissions, recycling waste gas, and further reducing the consumption cost of the GaN-MOCVD process.

(3) By some operations during running of the FTrSRMPSA system, for example, using ammonia containing purge waste gas (NH₃PW), generated by using the purge pressurization gas (PP) of an ammonia concentrate adsorbed phase as the purge gas (P), as the ammonia concentrated gas (NH₃CG), the disclosure obtains an ammonia recovery rate of 98-99%, and by returning nitrogen containing purge waste gas (N₂PW) generated by using the purge pressurization gas (PP) of the nitrogen containing adsorbed phase as the purge gas (P) into the intermediate gas (IG) buffer tank for cycle use, by appropriately adjusting rotation speeds ω₁ and ω₁′ of the upper and lower m- and m′-channel rotary valves, through a shared channel 3′ with two through holes of the m′-channel rotary valve of the ammonia containing adsorbed phase for the low-pressure intermediate gas (LPIG), the disclosure obtains H₂ product gas with a high yield of 92-95%, thereby significantly reducing energy consumption and emissions of desorbed gas, and simultaneously realizing high and low pressure (i.e., “divided concentrations” relative to non-adsorbed hydrogen) adsorption in the GaN-MOCVD process exhaust gas, as well as high purity and high yield in a simulated rotated PSA process on the basis of an axial flow fixed bed layer in the PSA process for extracting H₂ and NH₃ products from adsorbed gas and non-adsorbed gas. The obtained H₂ and NH₃ are then returned to the GaN-MOCVD process for recycling, thereby reusing the GaN-MOCVD process exhaust gas.

(4) The disclosure significantly reduces the number of program control valves and regulating valves in traditional axial flow fixed bed PSA or FTrPSA H₂/NH₃ extraction devices, and also reduces the complexity in manufacturing fast wheel PSA devices and can replace foreign imports, further reducing investment and production costs.

(5) The disclosure adapts to large fluctuation conditions of the GaN-MOCVD process exhaust gas, including components, concentration, pressure, flow rate, and the like by regulating and matching the rotation directions and rotation speeds (ω₁/ω₁′ and ω₂) of the m-/m′-multi-channel rotary valves and the annular rotary tray, has high operation flexibility, and can use conventional particle adsorbents to form a composite adsorbent bed instead of expensive regular adsorbents required for a rotary wheel or fast wheel PSA process.

(6) The disclosure adjusts and matches the rotation directions and rotation speeds of the multi-channel rotary valves and the annular rotary tray in each subsystem of the process, and the adsorption pressure and temperature, and adjusts and designs the height to diameter ratio of the adsorption towers based on the GaN-MOCVD process exhaust gas as the feed gas and the fluctuation conditions thereof, and the technical indicator requirements of the products H₂/NH₃, such that the radial diffusion in the axial flow fixed bed is negligible and a mature mass transfer model of the axial flow fixed bed is satisfied, and the influence of axial flow diffusion becomes smaller and smaller as the rotation speed of the annular rotary tray increases and the height to diameter ratio decreases, thereby making the mass transfer process inside the adsorption towers closer to a “steady-state” effect of the moving bed represented by a circulating bed, and the H₂/NH₃ products tend to have high purity and yield.

### BRIEF DESCRIPTION OF FIGURES

FIG. 1 is a flowchart of Example 1 of the disclosure.

FIG. 2 is a flowchart of Example 2 of the disclosure.

FIG. 3 is a flowchart of Example 3 of the disclosure.

### DETAILED DESCRIPTION

For those skilled in the art to better understand the disclosure, the technical solutions in the examples of the disclosure will be clearly and completely described below with reference to the accompanying drawings in the examples of the disclosure.

### Example 1

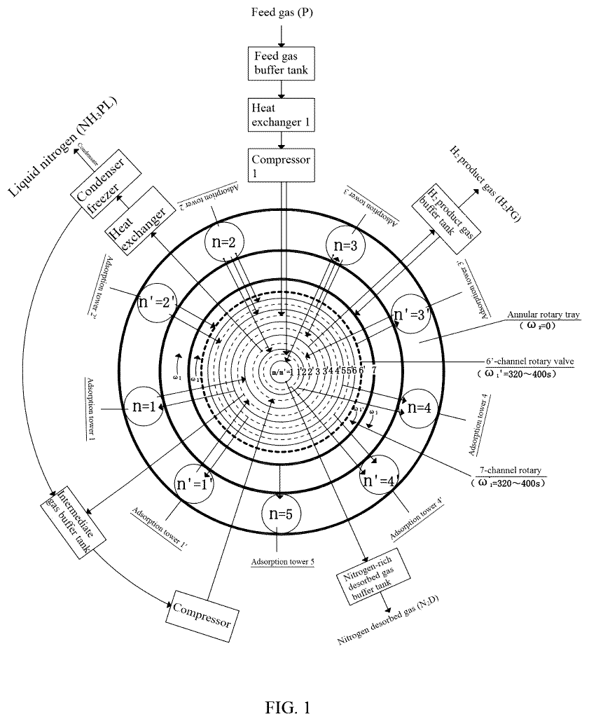

As shown in FIG. 1, in a full temperature range simulated rotated moving bed PSA process for extracting H₂ and NH₃ from GaN-MOCVD exhaust gas, the full temperature range simulated rotated moving bed PSA FTrSRMPSA system includes 4 axial flow fixed composite bed layer adsorption towers loaded with molecular sieves and activated carbon (n′=4′) with a height to diameter ratio of 3 and 5 axial flow fixed composite bed layer adsorption towers loaded with aluminum oxide, silica gel, activated carbon, molecular sieves/carbon molecular sieves (n=5) with a height to diameter ratio of 4, adsorption towers (n′+n=9) and corresponding driving mechanisms arranged on an annular rotary tray with a rotation speed of ω₂=0, upper and lower two independent rotating rotary valves rotating at rotation speeds of ω₁′=320-400 s and ω₁=210-300 s respectively with a channel number of (m′=6 and m=7) and arranged in the center of the annular tray, a feed gas (F) compressor 1 and intermediate gas (IG) compressor 2, an ammonia concentrated gas (NH₃CG) condenser cooler, and a feed gas (F)/intermediate gas (IG)/H₂ product gas (H₂PG)/nitrogen-rich desorbed gas (N₂D) buffer tank. The m-/m′-channel rotary valves are connected to the feed gas (F), the H₂ product gas (H₂PG), high/low pressure intermediate gas (H/LPIG), final repressurization gas of product hydrogen/feed gas (FR of H₂/F), ammonia concentrated gas (NH₃CG) consisting of ammonia-rich depressurization gas (NH₃D) and ammonia-containing purge waste gas (NH₃PW), non-condensable gas, and nitrogen-rich desorbed gas (N₂D) consisting of nitrogen-rich depressurization gas (D). The FTrSRMPSA system is formed by connecting inlets and outlets of the m-/m′-channel rotary valves with the hydrogen product gas (H₂PG), feed gas (F), high/low pressure intermediate gas (H/LPIG) buffer tank, and the material and process gas inlets and outlets of the ammonia concentrated gas (NH₃CG) condenser cooler, and process pipelines connected to internal pipelines of the annular rotary tray and the n/n′ adsorption towers between the upper and lower m-/m′-channel rotary valves. The rotation speed ω₁ of a 7-channel rotary valve (upper) is 210-300 s, the rotation speed ω₁′ of a 6′-channel rotary valve (lower) is 320-400 s, and the rotation speed ω₂ of the annular rotary tray is 0. Of the 6 channels in the 6′-channel rotary valve, one channel (m′=4′) is for pressurized feed gas (F), one shared channel (m′=3′) with 2 through holes is for low-pressure intermediate gas (LPIG), one shared channel (m′=5′) is for equalization drop (ED) and equalization rise (ER) of the concentrated ammonia adsorbed phase, one shared channel (m′=6′) is for purge pressurization gas (PP) and purge gas (P) of the concentrated ammonia adsorbed phase, one shared channel with 2 through holes (m′=2′) is for ammonia concentrated gas (NH₃CG) formed by the concentrated ammonia adsorbed phase depressurization gas (NH₃D) and ammonia-containing purge waste gas (NH₃PW), and one shared channel (m′=1′) is for the final repressurization gas (FR) of the pressurized feed gas (F) as the final repressurization gas (FR). Of the 7 channels in the 7-channel rotary valve, one channel (m=4) is for pressurized high pressure intermediate gas (HPIG), one channel (m=3) is for the hydrogen product gas (H₂PG), one shared channel (m=2) is for the first equalization drop (E1D) and equalization rise (EIR) of the nitrogen-containing adsorbed phase, one shared channel (m=5) is for the second equalization drop (E2D) and equalization rise (E2R) of the nitrogen-containing adsorbed phase, one shared channel (m=6) is for purge waste gas (N₂PW) formed by hydrogen-containing purge pressurization gas (PP) as nitrogen-containing adsorbed phase purge gas (P) and is shared with the m′=3′ channel, one channel (m=1) is for nitrogen-rich desorbed gas (N₂D) formed by nitrogen-rich depressurization gas (N₂D), and one channel (m=7) is for final repressurization gas (FR) of the hydrogen product gas (H₂PG) as the final repressurization gas (FR). Nitrogen-rich desorbed gas (N₂D) flowing out of an outlet end of the m-channel rotary valve flows through a material pipeline connected to the nitrogen-containing desorbed gas (N₂D) buffer tank, enters the buffer tank, or is directly discharged. Ammonia concentrated gas (NH₃CG) formed by ammonia-containing depressurization gas (D) flowing out of an outlet end of the m′-channel rotary valve and ammonia-containing purge waste gas (NH₃PW) flows through a material pipeline connected to a heat exchanger 2 (cooler) and a condenser freezer. Low pressure intermediate gas (LPIG) flowing out of the outlet end of the m′-channel rotary valve flows through a material pipeline connected to an intermediate gas (IG) buffer tank, a compressor 2, and a high pressure intermediate gas (HPIG) inlet end of the m-channel rotary valve. The condensate flowing out of the condenser freezer is a liquid ammonia product (NH₃PL), and non-condensable gas flows through a material pipeline connecting a non-condensable gas outlet end of the condenser freezer and an inlet of the intermediate gas (IG) buffer tank. The hydrogen product gas (H₂PG) flowing out of the outlet end of the m-channel rotary valve flows through a material pipeline connected to a hydrogen product gas (H₂PG) buffer tank. Hydrogen-containing final repressurization gas (H₂FR) flowing into an inlet end of the m-channel rotary valve flows through a material pipeline connecting the hydrogen product gas (H₂PG) buffer tank and a corresponding channel inlet end of the rotary valve. Ammonia-containing final repressurization gas (NH₃FR) flowing into an inlet end of the m′-channel rotary valve flows through a material pipeline connected to a feed gas (F) buffer tank, a heat exchanger 1 (heater) and a compressor 1. The feed gas (F) is epitaxial exhaust gas from a gallium nitride metal oxide chemical vapor deposition (GaN-MOCVD) epitaxial process, which typically includes components of 55% of hydrogen (H₂), 25% of nitrogen (N₂), and 20% of ammonia (NH₃) at room temperature and pressure. The feed gas (F) enters a material channel of the m′-channel rotary valve feed gas (F) (e.g., m′=4′), through a material pipeline connected to the feed gas (F) buffer tank, the heat exchanger 1 (for heating to 80-120° C.), the feed gas (F) compressor 1 (for pressurizing to 0.6-0.8 MPa), and an inlet through-hole of the rotary valve channel. Further, the feed gas (F) flows through a process pipeline formed by connecting an outlet of the channel to an internal pipeline of the annular tray and to an inlet end of an adsorption tower 1′, and enters the adsorption tower 1′ to perform a low pressure adsorption (LA) step, where the adsorption pressure is 0.6-0.8 MPa and the adsorption temperature is 80-120° C. NH₃ in the feed gas (F) is adsorbed and concentrated as an adsorbate. H₂ and N₂ are non-adsorbed phase gas, flow out as intermediate gas (IG) from an outlet end of adsorption tower 1′, and flow through a process pipeline connected to the adsorption tower 1′, an internal pipeline of the annular rotary tray, and a through hole of a material channel of the m′-channel rotary valve (e.g., m′=3′). The intermediate gas (IG) flows out from the outlet end of the m′-channel rotary valve, enters a low pressure intermediate gas (LPIG) buffer tank, and is pressurized by an intermediate gas (IG) compressor 2 to 2-3 MPa as feed gas of the adsorption tower 1. While a low pressure adsorption (LPA) step is performed in the adsorption tower 1′, the pressurized high pressure intermediate gas (HPIG) as the feed gas flows through a material pipeline connected to a through hole at a channel inlet of the m-channel rotary valve (e.g., m=4). As the m-channel rotary valve rotates clockwise, the high pressure intermediate gas (HPIG) flows through a process pipeline formed by connecting an outlet of the channel to the internal pipeline of the annular tray and to an inlet end of the adsorption tower 1 to enter the adsorption tower 1 to perform a high pressure adsorption (HPA) step, where the adsorption pressure is 2-3 MPa, and adsorbates are nitrogen (N₂), a small amount of ammonia (NH₃), and hydrogen (H₂) remaining in a dead space of an adsorption tower 2. Non-adsorbed phase gas flows out from an outlet end of adsorption tower 1, and flows through a process pipeline connected to the adsorption tower 1, an internal pipeline of the annular rotary tray, and a through hole of a material channel of the m-channel rotary valve (e.g., m=3). The non-adsorbed phase gas flows out from the outlet end of the m-channel rotary valve as the hydrogen product gas (H₂PG) and is input into the hydrogen product gas (H₂PG) buffer tank, where the hydrogen product gas (H₂PG) has a purity greater than or equal to 99.99%, and a pressure of 2-3 MPa. The hydrogen product gas (H₂PG) is either output, or purified in a hydrogen purification section of the gallium nitride epitaxial production process and then returned to the GaN-MOCVD epitaxial process for recycling. While the high pressure adsorption (HPA) step is performed in the adsorption tower 1, process and material pipelines connecting the m′-channel rotary valve to the adsorption tower 1′ that ends the low pressure adsorption (LPA) step are synchronously rotated clockwise with the m′-channel rotary valve to the position of an adsorption tower 2′ (n′=2′) in FIG. 1, and are abutted against the adsorption tower 2′, such that the adsorption tower 2′ enters equalization drop (ED) and purge pressurization (PP) steps of the ammonia concentrate adsorbed phase. Resulting equalization drop gas (ED) flows through a shared channel in the m′-channel rotary valve (e.g., m′=5′) and a process pipeline connected to a corresponding internal pipeline of the annular rotary tray and an adsorption tower 4′, to perform pressure equalization on the adsorption tower 4′ (n′=4′) in an equalization rise (ER) step of the ammonia concentrate adsorbed phase, where the pressure inside the adsorption tower 2′ drops to 0.3-0.4 MPa. The purge pressurization gas (PP) generated by purge pressurization (PP) flows through a shared channel in the m′-channel rotary valve (e.g., m′=6′) and a process pipeline connected to a corresponding internal pipeline of the annular rotary tray and an adsorption tower 3′, to purge the adsorption tower 3′ (n′=3′) in a purge (P) step of the ammonia concentrate adsorbed phase. While the purge pressurization (PP) and purge (P) steps of the ammonia concentrate adsorbed phase are performed in the adsorption tower 2′, as the m-channel rotary valve synchronously rotates clockwise to the position of an adsorption tower 2 (n=2) as shown in FIG. 1, the adsorption tower 2 enters first equalization drop (E1D), second equalization drop (E2D), and purge pressurization (PP) steps of the nitrogen-rich adsorbed phase. Resulting first equalization drop gas (E1D) and second equalization drop gas (E2D) flow through a shared channel in the m-channel rotary valve (e.g., m=2 and 5) and a process pipeline connected to a corresponding internal pipeline of the annular rotary tray and the adsorption tower 2, to perform pressure equalization on an adsorption tower 4 (n=4) in the first and second equalization rise (E1R and E2R) steps of the ammonia-containing adsorbed phase, where the pressure inside the adsorption tower 2 drops to 0.3-0.4 MPa. The purge pressurization gas (PP) generated by purge pressurization (PP) flows through a shared channel in the m-channel rotary valve (e.g., m=6) and a process pipeline connected to a corresponding internal pipeline of the annular rotary tray and an adsorption tower 3, to purge the adsorption tower 3 (n=3) in a purge (P) step of the ammonia-containing adsorbed phase. As the m-channel rotary valve synchronously rotates clockwise to the position of the adsorption tower 3 (n=3) as shown in FIG. 1, the adsorption tower 3 enters depressurization (D) and purge (P) steps of the nitrogen-containing adsorbed phase. Depressurization gas (D) as the nitrogen-rich desorbed gas (N₂D) flows through a shared channel in the m-channel rotary valve (e.g., m=1), and a material and process pipeline connected to a corresponding internal pipeline of the annular rotary tray and the adsorption tower 3. The nitrogen-rich desorbed gas (N₂D) flows out from an outlet end of an m=1 channel of the m-channel rotary valve and enters the nitrogen-rich desorbed gas (N₂D) buffer tank before being discharged. Then, purge pressurization gas (PP) generated from the adsorption tower 2 in the purge pressurization (PP) step is used as purge gas (P) for purging the adsorption tower 3 in the purge (P) step (P). Resulting nitrogen-containing purge waste gas (N₂PW) as low pressure intermediate gas (LPIG) flows through one through hole of a shared channel that is located exactly in the n′-channel rotary valve (e.g., m′=3′), has 2 through holes and is for intermediate gas (IG), and a material and process pipeline connected to a corresponding internal pipeline of the annular rotating tray and the adsorption tower 3, flows out from an outlet end of an m′=3′ channel of the m′-channel rotary valve, and enters the low pressure intermediate gas (IG) buffer tank for recycling. While corresponding desorption steps are performed in the adsorption towers 2 and 3 with n=2 and n=3 of the nitrogen-containing adsorbed phase, as the m′-channel rotary valve rotates clockwise to the position of the adsorption tower 3′ (n′=3′) as shown in FIG. 1, the adsorption tower 3′ enters depressurization (D) and purge (P) steps of the ammonia concentrate adsorbed phase. Ammonia-rich (concentrated) depressurization gas (NH₃D) generated by depressurization (D) and following ammonia-rich purge waste gas (NH₃PW) generated after purging (P) with ammonia-containing purge pressurization gas (PP) flowing out of the adsorption tower 2′ in a purge pressurization (PP) step, as the ammonia concentrated gas (NH₃CG), flow through a shared channel in the n′-channel rotary valve (e.g., m′=2′) and a material and process pipeline connected to a corresponding internal pipeline of the annular rotary tray and the adsorption tower 3′, flow out from an outlet end of a 2′ channel of the n′-channel rotary valve, and pass through the heat exchanger 2 (cooler) and the condenser freezer to form a condensate which is a liquid ammonia product (NH₃PL) with an ammonia purity of 99.99% or higher, and is output for use. The formed non-condensable gas flows through a material pipeline and returns to the low pressure intermediate gas (IG) buffer tank for recycling. While a corresponding desorption step of the ammonia-containing adsorbed phase is performed in the adsorption tower 3′, as the m-channel rotary valve rotates clockwise to the position of the adsorption tower 4 (n=4) as shown in FIG. 1, the adsorption tower 4 enters second equalization rise (E2R) and first equalization rise (E1R) steps of the nitrogen-containing adsorbed phase. First and second equalization rise (E1R and E2R) is performed sequentially in the adsorption tower 2 in the steps of first equalization drop (E1D) and second equalization drop (E2D). Shared channels in the m-channel rotary valve used are m=2 and m=5, respectively. While the second equalization rise (E1R and E2R) steps and waiting in a waiting area are performed in the adsorption tower 4, as the m′-channel rotary valve rotates clockwise to the position of the adsorption tower 4′ (n′=4′) as shown in FIG. 8, the adsorption tower 4′ enters equalization rise (ER) and final repressurization (FR) steps of the ammonia-containing adsorbed phase. Equalization drop gas (ED) generated by the adsorption tower 2′ in an equalization drop (ED) step of the ammonia-containing adsorbed phase flows through a shared channel of the m′-channel rotary valve (e.g., m′=5′), and a material and process pipeline connected to a corresponding internal pipeline of the annular rotary tray and the adsorption tower 4′ for pressure equalization in the adsorption tower 4′, and then feed gas (F) is used as final repressurization gas (FR) and flows through a channel of the m′-channel rotary valve (e.g., m′=1′) and a material and process pipeline connected to a corresponding internal pipeline of the annular rotary tray and the adsorption tower 4′ for final repressurization (FR) in the adsorption tower 4′ to achieve an adsorption pressure of 0.6-0.8 MPa in the adsorption tower 4′ required for a low pressure adsorption (LPA) step. Thus, a complete closed-loop PSA cycle operation of the ammonia concentrate adsorbed phase is achieved in the adsorption tower 1′, i.e., the following steps: low pressure adsorption (LPA), equalization drop (ED)/purge pressurization (PP), depressurization (D)/purge (P), and equalization rise (ER)/final repressurization (FR). Then, the adsorption tower 1′ enters a next closed-loop cycle operation process of adsorption and desorption. While the m′-channel rotary valve continuously rotates during the closed-loop cycle operation process of adsorption and desorption in the adsorption tower 1′, corresponding material gas and process gas entering and exiting the adsorption towers 2′, 3′ and 4′ are switched between entry and exit positions to perform the corresponding closed-loop cycle operation steps of adsorption and desorption. The closed-loop cycle operation steps of each of the 4 (n′=4′) adsorption towers correspond to the closed-loop cycle operation steps of each of the other 3 adsorption towers. As a result, a liquid ammonia product (NH₃PL) with an ammonia concentration greater than or equal to 99.99% (v/v) is continuously produced from the GaN-MOCVD process exhaust gas as the feed gas, and the yield of the liquid ammonia product is 98-99%. Meanwhile, during the final repressurization (FR) in the adsorption tower 4′, as the m-channel rotary valve rotates clockwise to the position of the adsorption tower 5 (n=5) as shown in FIG. 1, the adsorption tower 5 enters a final repressurization (FR) step of the nitrogen-rich adsorbed phase. Hydrogen product gas (H₂PG) is used as final repressurization gas (FR) and flows through a channel of the m-channel rotary valve (e.g., m=7) and a material and process pipeline connected to a corresponding internal pipeline of the annular rotary tray and the adsorption tower 5 for final repressurization (FR) in the adsorption tower 5 to achieve an adsorption pressure of 2-3 MPa in the adsorption tower 5 required for a high pressure adsorption (HPA) step. Thus, a complete closed-loop PSA cycle operation of the nitrogen-containing adsorbed phase is achieved in the adsorption tower 1, i.e., the following steps: high pressure adsorption (HPA), first equalization drop (E1D)/second equalization drop (E2D)/purge pressurization (PP), depressurization (D)/purge (P), second equalization rise (E2R)/first equalization rise/waiting area, and final repressurization (FR). Then, the adsorption tower 1 enters a next closed-loop cycle operation process of adsorption and desorption. While the m-channel rotary valve continuously rotates during the closed-loop cycle operation process of adsorption and desorption in the adsorption tower 1, corresponding material gas and process gas entering and exiting the adsorption towers 2, 3, 4 and 5 are switched between entry and exit positions to perform the corresponding closed-loop cycle operation steps of adsorption and desorption. The closed-loop cycle operation steps of each of the 5 (n=5) adsorption towers correspond to the closed-loop cycle operation steps of each of the other 4 adsorption towers. As a result, an H₂ product gas (H₂PG) with a hydrogen (H₂) concentration greater than or equal to 99.99% (v/v) is continuously produced from the GaN-MOCVD process exhaust gas as the feed gas, and the yield of the H₂ product gas is 92-95%. As a result, energy consumption and emissions of desorbed gas can be significantly reduced, and high and low pressure (i.e., “divided concentration” relative to non-adsorbed hydrogen) adsorption in the GaN-MOCVD process exhaust gas, and both high purity and high yield in a simulated rotated PSA process on the basis of an axial flow fixed bed layer in the PSA process for extracting H₂ and NH₃ products from adsorbed phase gas and non-adsorbed phase gas. The obtained H₂ and NH₃ are then returned to the GaN-MOCVD process for recycling, thereby reusing the GaN-MOCVD process exhaust gas.

### Example 2

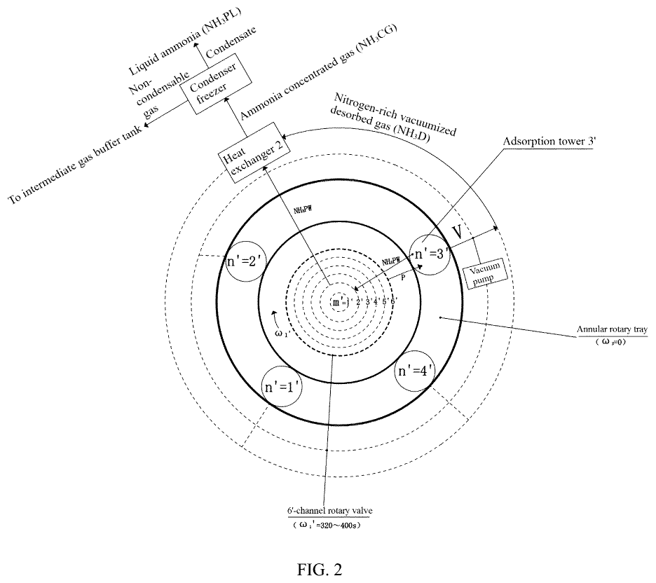

As shown in FIG. 2, based on Example 1, the depressurization (D) step of the ammonia concentrate adsorbed phase is replaced with a vacuumizing (V) desorption step in the medium and high temperature PSA ammonia concentration system. Desorbed gas (D) formed by vacuumizing (V) flows out from an outlet end of an n′ (e.g., n′=3′) adsorption tower and flows through an external pipeline connected to an outlet end of the adsorption tower on the annular rotary tray. A vacuum pump and a control valve are arranged on the external pipeline to control a flow rate of the desorbed gas (D) before entering the ammonia-rich (concentrate) desorbed gas (NH₃D) buffer tank, with a maximum vacuum degree of −0.08 MPa. Correspondingly, an original depressurization gas (D) channel (e.g., m′=2′) in the 6′-channel rotary valve becomes an empty channel. Subsequently, ammonia-rich purge waste gas (NH₃PW), generated when purge pressurization gas (PP) is used as purge gas (P) for purging (P), enters the empty channel, and is then mixed with ammonia-rich desorbed gas (NH₃D) to form ammonia concentrated gas (NH₃CG) which enters a condenser freezer through a heat exchanger 2 (cooler) to obtain a liquid ammonia product (NH₃PL) with a purity greater than or equal to 99.995% and a yield greater than or equal to 99%. In addition, the purge pressurization gas (PP) used as the purge gas (P) also fills the vacuum in the adsorption tower, causing the n′ adsorption tower to return to normal pressure or slightly positive pressure, and also correspondingly alleviate the significant decrease in the ammonia content in non-adsorbed intermediate gas (IG) and non-condensable gas flowing out from a condenser freezer (refrigerator) as low pressure intermediate gas (LPIG), thereby greatly prolonging the service life of adsorbents in the intermediate gas PSA hydrogen purification system and the service life of adsorbents in the medium and high temperature PSA ammonia concentration system.

### Example 3

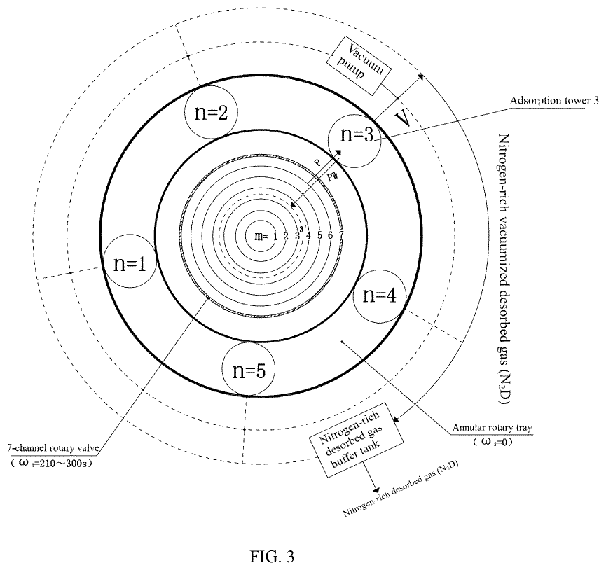

As shown in FIG. 3, based on Examples 1 and 2, the depressurization (D) step of the ammonia concentrate adsorbed phase is replaced with a vacuumizing (V) desorption step in the intermediate gas PSA hydrogen purification system. Nitrogen-rich desorbed gas (N₂D) formed by vacuumizing (V) flows out from the outlet end of an n (e.g., n=3) adsorption tower and flows through an external pipeline connected to the outlet end of the adsorption tower on the annular rotary tray. A vacuum pump and a control valve are arranged on the external pipeline to control the flow rate of the nitrogen-rich desorbed gas (N₂D) before entering the nitrogen-rich desorbed gas (N₂D) buffer tank, with a maximum vacuum degree of −0.08 MPa. Correspondingly, an original depressurization gas (D) channel (e.g., m=1) in the 7-channel rotary valve becomes an empty channel. Adsorbents in the n adsorption tower are completely desorbed, resulting in H₂ product gas (H₂PG) with a purity greater than or equal to 99.999% and a yield greater than or equal to 95%, thereby further prolonging the service life of the adsorbents.

Obviously, the above examples are only a part of the examples of the disclosure, but not all of them. Based on the examples recorded in the disclosure, all other examples obtained without creative work or structural changes made under the teaching of the disclosure by those skilled in the art, which have the same or similar technical solutions to those of the disclosure, fall within the protection scope of the disclosure.

What is claimed is:

1. A full temperature range simulated rotated moving bed PSA process for extracting H₂ and NH₃ from GaN-MOCVD exhaust gas, wherein a full temperature range simulated rotated moving bed PSA (FTrSRMPSA) system comprises a multi-tower medium temperature PSA concentration system (comprising a driving mechanism) with n (4≤n≤40, a natural integer) adsorption towers, a multi-tower medium and low temperature intermediate gas PSA system (comprising a driving mechanism) with n′ (4≤n′≤40, a natural integer) adsorption towers, an H₂ product gas (H₂PG)/feed gas (F)/intermediate gas (IG)/nitrogen-rich desorbed gas (N₂D) buffer tank, a liquid ammonia product storage tank, a feed gas compressor 1/intermediate gas compressor 2, a feed gas heat exchanger 1 (heater)/ammonia concentrated gas heat exchanger 2 (cooler)/condenser freezer, as well as corresponding materials and process pipelines; a medium and high temperature PSA ammonia concentration system of n axial flow fixed composite bed adsorption towers (“n adsorption towers” for short) loaded with various adsorbents and having a certain height to diameter ratio and an intermediate gas PSA hydrogen purification system of n′ axial flow fixed composite bed adsorption towers (“n′ adsorption towers” for short) loaded with various adsorbents and having a certain height to diameter ratio are formed by the n adsorption towers and the n′ adsorption towers (i.e., n+n′ adsorption towers) arranged uniformly at intervals respectively on an annular rotary tray with a rotation speed of ω₂ (second/revolution), the corresponding driving mechanisms, m (5≤m≤36, a natural integer) channels and m′ (5≤m′≤36, a natural integer) channels arranged in the center of the annular tray, and the upper and lower two independently rotating multichannel rotary valves with the rotation speeds of ω₁ (second/revolution) and ω₁′ (second/revolution) respectively; the upper rotary valve is called an m-channel rotary valve for short, and the lower rotary valve is called an m′-channel rotary valve for short; inlet and outlet ends of the m- and m′-channels are respectively connected to inlets and outlets of the m-/m′-channel rotary valves, inlets and outlets of internal pipelines of the rotary tray, and inlet and outlet ends of the n/n′ adsorption towers through material and process pipelines that are respectively connected to the internal pipelines of the annular rotary tray and the inlet and outlet ends of corresponding n adsorption towers/n′ adsorption towers and connected to the H₂ product gas/feed gas/intermediate gas/nitrogen-rich desorbed gas buffer tanks and the feed gas compressor 1/heat exchanger 1/intermediate gas compressor 2/ammonia concentrated gas heat exchanger 2/ammonia condenser freezer; the process flow is as follows: the exhaust gas generated in a GaN-MOCVD epitaxial process is used as feed gas (F), which typically comprises the following main components: 55% (v/v, similar below) of hydrogen (H₂), 25% of nitrogen (N₂), 20% of ammonia (NH₃), and the balance of small or trace amounts of metal ions, particulate matter, methane (CH₄), oxygen (O₂), and oxides comprising carbon monoxide (CO), carbon dioxide (CO₂) and water (H₂O) at a temperature of 25-40° C. and a normal or slightly positive pressure; the feed gas (F) flowing out of the feed gas buffer tank, which is heated by the heat exchanger 1 to 80-120° C. and pressurized by the compressor 1 to 0.6-0.8 MPa, enters the channels of the m-channel rotary valve in the medium and high temperature PSA ammonia concentration system and the internal pipelines of the annular rotary tray to enter a certain adsorption tower of the n adsorption towers, for medium and high temperature PSA ammonia concentration; ammonia concentrated gas (NH₃CG) consisting of ammonia-rich depressurization gas (NH₃D) and ammonia-rich purge waste gas (NH₃PW) continuously produced from the system has an ammonia concentration of greater than or equal to 90-95%, and is cooled to 25-40° C. by the heat exchanger 2 before entering an ammonia condensation and refrigeration unit; a resulting condensate is a liquid ammonia product (NH₃PL), which has a concentration of 99.99-99.999% and a yield of 98-99%, and is fed into a liquid ammonia product tank; resulting non-condensable gas enters an intermediate gas (IG) buffer tank as low pressure intermediate gas (LPIG), and non-adsorbed phase gas flowing out of the medium and high temperature PSA ammonia concentration system enters the intermediate gas (IG) buffer tank as low pressure intermediate gas (LPIG), flows out of the buffer tank together with the non-condensable gas as the low pressure intermediate gas (LPIG), and is pressurized by the intermediate gas (IG) compressor 2 to 2.0-3.0 MPa to form high pressure intermediate gas (HPIG); the high pressure intermediate gas (HPIG) enters the channels of the m′-channel rotary valve of the intermediate gas PSA hydrogen purification system, and enters a certain adsorption tower of the n′ adsorption towers through an internal pipeline of the annular rotary tray, for intermediate gas PSA hydrogen purification; a non-adsorbed phase hydrogen gas product (H₂PG) is continuously produced from the system, and has a purity of 99.99-99.999% and a yield of 92-95%; nitrogen-rich desorbed gas (N₂D) of the absorbed phase continuously flowing out of the system enters the nitrogen-rich desorbed gas (N₂D) buffer tank and flows out, or is directly discharged, or is subjected to cryogenic nitrogen production and H₂ recovery, or undergoes membrane separation for H₂ recovery; thus, a complete full temperature range simulated rotated moving bed PSA (FTrSRMPSA) separation and purification process for producing high-purity and high-yield H₂ and NH₃ from GaN-MOCVD process exhaust gas as the feed gas is formed; and high-purity H₂ product gas (H₂PG) with a purity greater than or equal to 99.99% and a yield greater than or equal to 92%, and a liquid ammonia product (NH₃PL) with a purity greater than or equal to 99.99% and a yield greater than or equal to 98% are obtained from the GaN-MOCVD process exhaust gas, and returned to the GaN-MOCVD process for recycling.

2. The full temperature range simulated rotated moving bed PSA process for extracting H₂ and NH₃ from GaN-MOCVD exhaust gas according to claim 1, wherein regulation and matching of rotation directions of the m- and m′-channel rotary valves and the annular rotary tray in the medium and high temperature PSA ammonia concentration system and the intermediate gas PSA hydrogen purification system and rotation speeds (ω₁, ω₁′ and ω₂) thereof comprise: 1) synchronization in the same direction, i.e., rotating clockwise or counterclockwise in the same direction, with ω₁=ω₁′=ω₂/≠0, and 2) asynchronization in the same direction, i.e., rotating clockwise or counterclockwise in the same direction, with either ω₁≠0≥ω₁′≠0/ω₂=0, or ω₁≠0≤ω₁′≠0/ω₂=0, or ω₁=ω₁′=0/ω₂≠0, preferably, asynchronization in the same direction, i.e., rotating clockwise or counterclockwise in the same direction with ω₁≠0≤ω₁′/ω₂=0.

3. The full temperature range simulated rotated moving bed PSA process for extracting H₂ and NH₃ from GaN-MOCVD exhaust gas according to claim 1, wherein the n adsorption towers in the medium and high temperature PSA ammonia concentration system sequentially and alternately go through adsorption and desorption cycle operation steps of adsorption (A), equalization drop (ED)/purge pressurization (PP), depressurization (D)/purge (P), equalization rise (ER)/waiting area (-), and final repressurization (FR); the maximum number of times of pressure equalization is 2, comprising first equalization drop (E1D)/first equalization rise (E1R) and second equalization drop (E2D)/second equalization rise (E2R); the steps of purge pressurization (PP) and waiting (-) need to be flexibly arranged according to the alternating timing of each adsorption tower during the PSA cycle operations; the n adsorption towers sequentially and alternately going through the PSA cycle operation steps is achieved by regulation and matching of rotation directions of the m-channel rotary valve and the annular rotary tray in the medium and high temperature PSA ammonia concentration system, and rotation speeds (ω₁ and ω₂) thereof, and each channel in the m-channel rotary valve alternately switching materials and process gas flowing in the PSA cycle operation process at regular intervals to enter the n adsorption towers to perform the PSA cycle operations.

4. The full temperature range simulated rotated moving bed PSA process for extracting H₂ and NH₃ from GaN-MOCVD exhaust gas according to claim 1, wherein the n′ adsorption towers in the intermediate gas PSA hydrogen purification system sequentially and alternately go through adsorption and desorption cycle operation steps of adsorption (A), equalization drop (ED)/purge pressurization (PP), depressurization (D)/purge (P), equalization rise (ER)/waiting area (-), and final repressurization (FR); the maximum number of times of pressure equalization is 3, comprising first equalization drop (E1D)/first equalization rise (ER), second equalization drop (E2D)/second equalization rise (E2R), and third equalization drop (E3D)/third equalization rise (E3R); the steps of purge pressurization (PP) and waiting (-) need to be flexibly arranged according to the alternating timing of each adsorption tower during the PSA cycle operations; the n′ adsorption towers sequentially and alternately going through the PSA cycle operation steps is achieved by regulation and matching of rotation directions of the m′-channel rotary valve and the annular rotary tray in the intermediate gas PSA hydrogen purification system and rotation speeds (ω₁′ and ω₂) thereof, and each channel in the m′-channel rotary valve alternately switching materials and process gas flowing in the PSA cycle operation process at regular intervals to enter the n′ adsorption towers to perform the PSA cycle operations.

5. The full temperature range simulated rotated moving bed PSA process for extracting H₂ and NH₃ from GaN-MOCVD exhaust gas according to claim 1, wherein purge gas (P) in the medium and high temperature PSA ammonia concentration system and the intermediate gas PSA hydrogen purification system which is either the purge pressurization gas (PP)/intermediate gas (IG) from inside the system, or the H₂ product gas (H₂PG)/ammonia concentrated gas (NH₃CG) from outside the system is used to purge in batches through one or more openings in the rotary valve channels (conduits), with a maximum of 4 openings, preferably the purge pressurization gas (PP) from inside the system is used as the purge gas (P).

6. The full temperature range simulated rotated moving bed PSA process for extracting H₂ and NH₃ from GaN-MOCVD exhaust gas according to claim 1, wherein the depressurization (D) step in the medium and high temperature PSA ammonia concentration system and the intermediate gas PSA hydrogen purification system is performed by vacuumizing for desorption; an added vacuum pump is either connected to a stream pipeline for the desorbed gas (D) outflow from the rotary valve, or directly connected to an external pipeline connected to an outlet end of the adsorption tower on the annular rotary tray, with a control valve installed on the external pipeline, preferably, the added vacuum pump is directly connected to an external pipeline connected to the outlet end of the adsorption tower on the annular rotary tray, with a control valve installed on the external pipeline.

7. The full temperature range simulated rotated moving bed PSA process for extracting H₂ and NH₃ from GaN-MOCVD exhaust gas according to claim 1, wherein final repressurization gas (FR) in the PSA cycle operation of the medium and high temperature PSA ammonia concentration system and the intermediate gas PSA hydrogen purification system is either the feed gas (F), or the intermediate gas (IG), or the ammonia concentrated gas (NH₃CG), or the H₂ product gas (H₂PG), from outside the system; and when the purity of the H₂ product gas (H₂PG) is greater than 99.99%, the final repressurization gas (FR) is preferably the H₂ product gas (H₂PG).

8. The full temperature range simulated rotated moving bed PSA process for extracting H₂ and NH₃ from GaN-MOCVD exhaust gas according to claim 1, wherein the n adsorption towers and the n′ adsorption towers of the medium and high temperature PSA ammonia concentration system and the intermediate gas PSA hydrogen purification system are respectively loaded with one or more combined adsorbents of active calcium chloride, activated carbon, and molecular sieves, and one or more combined adsorbents of aluminum oxide, silica gel, activated carbon, molecular sieves, and carbon molecular sieves, preferably, the adsorption towers in the two systems are loaded with two or more combined adsorbents to form composite adsorbent bed layers.
